(19) United States
(12) Patent Application Publication
(10) Pub. No.: US 2005/0017956 A1
(43) Pub. Date: Jan. 27, 2005

(54) Touch panel

(75) Inventor: Che-Kuei Mai, Hsinchu (TW)

Correspondence Address: LOWE HAUPTMAN GOPSTEIN GILMAN & BERNER, LLP, Suite 310, 1700 Diagonal Road, Alexandria, VA, 22314, US

(73) Assignee: TOPPOLY OPTOELECTRONICS CORP.

(21) Appl. No.: 10/774,518

(22) Filed: Feb. 10, 2004

(30) Foreign Application Priority Data
Jul. 24, 2003 (TW) 92120179

(51) Int. Cl. G09G 5/00

(52) U.S. Cl. 345/173

(57) ABSTRACT

The FPC is connected to one edge of touch panel by the bonding method, and the FPC with parts of the conductive lines put originally on the edge of touch panel is folded and overlapped over touch panel. Therefore, the entire area of touch panel can be diminished.

### BACKGROUND OF THE INVENTION

1. Field of the Invention

The invention relates to a design of touch panel, more particularly to a design of touch panel including a flexible printed circuit board (FPC) to diminish the entire area of touch panel.

2. Description of the Prior Art

The touch panel is the common product in daily life. For example, the touch panel is incorporated into the ATM (Automatic Teller Machines) in the bank or at the corner to provide the user with the withdraw/deposit applications, or the automatic tourism guide device in the scenic spot to provide the user with the introductions to the scenic spot and tour route. Besides, there is so-called touch pad in the notebook for the purpose of replacing the mouse and providing the function of the handwriting input. The PDA (Personal Digital Assistant) and Tablet PC also provide the different applications to the touch panel.

A diagram indicating the basic constitution of a general touch panel 100, as shown in FIG. 1, has an upper electrode plate 110 and a lower electrode plate 120. The upper conductive lines 116 are connected electrically to the upper electrode plate 110 and the lower conductive lines 126 are connected electrically to the lower electrode plate 120, respectively. The dot spacers 130 are located in between the upper electrode plate 110 and the lower electrode plate 120 to isolate electrically the upper electrode plate 110 and the lower electrode plate 120. The upper electrode plate 110 has a base substrate 112 and a conductive layer 114 formed beneath the base substrate 112, and the lower electrode plate 120 has a base substrate 122 and a conductive layer 124 formed on the base substrate 122. If the touch panel is put on the liquid crystal display device, the material of the conductive layers 114, 124 must be transparent, such as ITO (indium tin oxidation) or IZO (indium zinc oxidation). FIG. 2 illustrates the cross-sectional structure view of the touch panel 100. The dot spacers 130 are used to separate the upper electrode plate 110 and the lower electrode plate 120, and an adhesive layer (not shown in FIG) is used to adhere the upper electrode plate 110 and the lower electrode plate 120. The top structure view of touch panel 100 is illustrated as FIG. 3. An active area 102 is located in the middle area of the touch panel 100 to provide the user with the touch area. The transparent area 104 must be transparent to show the figures if the touch panel 100 is put over the liquid crystal display device and bigger than the active area 102. At the surroundings of the transparent area 104, there is the edge area 106 that the upper conductive lines 116 and the lower conductive lines 126 can be formed on.

The both ends of upper conductive lines 116 are connected to two different voltages; similarly, the both ends of lower conductive lines 126 are connected to two different voltages. Therefore, the upper electrode plate 110 and the lower electrode plate 120 present a voltage gradient respectively. When one position on the touch panel 100 is pressed by a pen or finger, the distance and the capacitance between the upper electrode plate 110 and the lower electrode plate 120 of the pressed position are altered. So the voltage gradients of the upper electrode plate 110 and the lower electrode plate 120 are altered. We can get the pressed position of the touch panel 100 by calculating the difference of original and altered voltage gradients.

As for the consumer electrical products, the consumer or user often prefers the slim body, the small volume, and the low price. Hence, the touch panel incorporated into the consumer products is usually the resistance-type with the structure such as Film-Glass, Film-Plastic or Film-Film. The manufacturer disposes the dot spacers, which can prevent from the unnecessary respondence incurring by the unexpected touch between the upper electrode plate and the lower electrode plate, between two electrode plates in the design of the resistance-type touch panel. The dot spacers can not only avoid the unnecessary respondence of the touch panel, but also control the user's handwriting and the Newton Ring.

The common method to manufacture the dot spacers for the touch panel is the screen-printing method. However, as for the high-quality resistance-type touch panel with the structure of Glass-Glass, the liquid crystal will be put into between the glasses.

The conductive lines at the output terminal areas of the upper and lower electrode plates usually adopt the structure of silver bus in the manufacturing process of the touch panel. But the silver bus expands by the heat and shrinks by the cold. Therefore, for the purpose of retaining reliability of the circuit of the touch panel, we will use the broader silver bus to get the better quality. However, the broader silver bus will generate the larger touch panel. For the users, such panel cannot meet their requests for the slim body. In addition, there are asymmetrical areas at the edges of touch panel due to the broader silver bus as illustrated in FIG. 3. It is quite inconvenient for the designer of the consumer electrical products.

Because the transparent conductive films are put on the upper and lower substrates for the current resistance-type liquid crystal touch panel, the design of the silver bus at the edges usually uses the staggering and overlapping design. Such design that needs the certain width of the surrounding areas also results in the asymmetrical areas at both sides of the touch panel. Besides, the humidity and the heat affect the silver bus easily, so we must insulate the silver bus with the isolated rubber at the surrounding areas. It is another reason that the surrounding areas cannot be diminished.

### SUMMARY OF THE INVENTION

In the light of the state of the art described above, the present invention diminishes the entire area of touch panel. A flexible printed circuit board (FPC) is connected to one edge of touch panel, and the FPC is folded and overlapped over touch panel. The FPC is connected to the touch panel by the bonding method and parts of the conductive lines put originally on the edge of touch panel are designed on the FPC.

This invention equalizes the areas of two/four sides of touch panel, and then the touch panel can be incorporated into more consumer electrical products.

There is provided according to a general aspect of the present invention a touch panel comprises an upper electrode plate; a lower electrode plate being isolated electrically with the upper electrode plate; a plurality of conductive lines connected electrically to the upper electrode plate and the lower electrode plate respectively; and a flexible printed circuit board connected electrically to a terminal area of the touch panel, parts of the plurality of conductive lines located on the terminal area, wherein the folded parts of the flexible printed circuit board are overlapped over the touch panel.

Base on the idea described above, the touch panel further comprises a second flexible printed circuit board connected electrically to the touch panel.

Base on the idea described above, wherein the first flexible printed circuit board is connected electrically to the touch panel by the bonding method.

Base on the aforementioned idea, the touch panel further comprises a plurality of dot spacers located in between the upper electrode plate and the lower electrode plate.

There is provided according to a general aspect of the present invention a touch panel comprises a first electrode plate; a second electrode plate being isolated electrically with the first electrode plate; a plurality of dot spacers located in between the first electrode plate and the second electrode plate; a plurality of first conductive lines connected electrically to the first electrode plate and the second electrode plate respectively; and a flexible printed circuit board connected electrically to a terminal area of the touch panel by the bonding method, a plurality of second conductive lines located on the FPC and connected electrically with the plurality of first conductive lines, wherein the folded parts of the flexible printed circuit board are overlapped over the touch panel to diminish the entire area of the touch panel.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a constitution view of conventional touch panel;

FIG. 2 illustrates a cross-sectional structure view of conventional touch panel;

FIG. 3 illustrates a top view of conventional touch panel;

FIG. 4 illustrates a top view of touch panel according to the first embodiment of this invention, wherein the FPC at the edge of touch panel is not folded yet;

FIG. 5 illustrates a top view of touch panel according to the first embodiment of this invention, wherein the FPC at the edge of touch panel is already folded;

FIG. 6 illustrates a top view of touch panel according to the second embodiment of this invention, wherein the FPC at the edge of touch panel is not folded yet; and

FIG. 7 illustrates a top view of touch panel according to the second embodiment of this invention, wherein the FPC at the edge of touch panel is already folded.

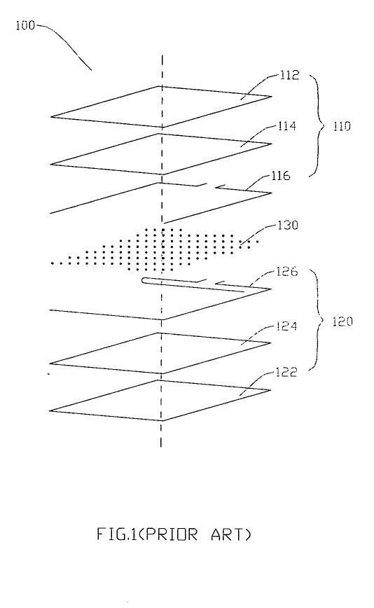

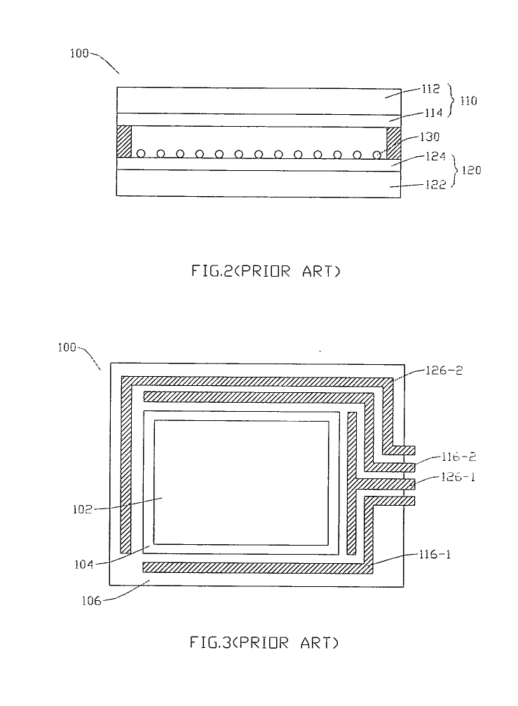

### DESCRIPTION OF THE PREFERRED EMBODIMENT

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

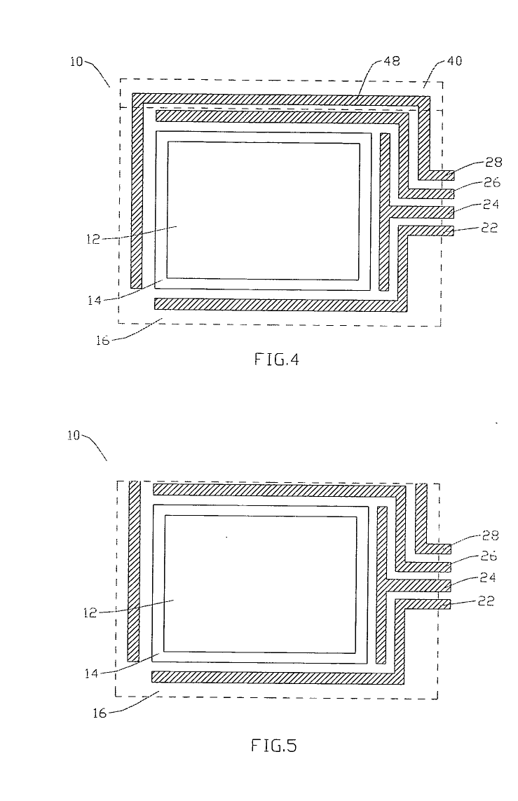

The first embodiment of this invention is illustrated in the FIG. 4, an active area 12 is located in the middle area of the touch panel to detect the touch position of a pen or finger. Most areas of the touch panel 10 must be transparent if the touch panel 10 is put on the liquid crystal display device, and the transparent area 14 is bigger than the active area 12. At the surroundings of the active area 12, four conductive lines 22, 24, 26, 28 are disposed around the active area 12 and connected electrically with the electrode plates of the touch panel 10 respectively. The four conductive lines 22, 24, 26, 28, which material are silver, are located in the conductive area 16. It is the main object of this invention to diminish the conductive area 16. A flexible printed circuit (FPC) board 40 with a conductive line 48 is disposed at one edge of the touch panel 10. The both ends of the conductive line 48 are connected respectively to the two parts of the conductive line 28. The FPC 40 can be connected to the touch panel 10 by the bonding method.

The area of the FPC 40 is taken away from the entire area of the touch panel 10 after the FPC 40 is folded, as shown in the FIG. 5. Besides, the thickness of the FPC 40 is very thin, so it adds only little volume of the touch panel 10. The request of slim body and small volume for touch panel can 10 be made easily.

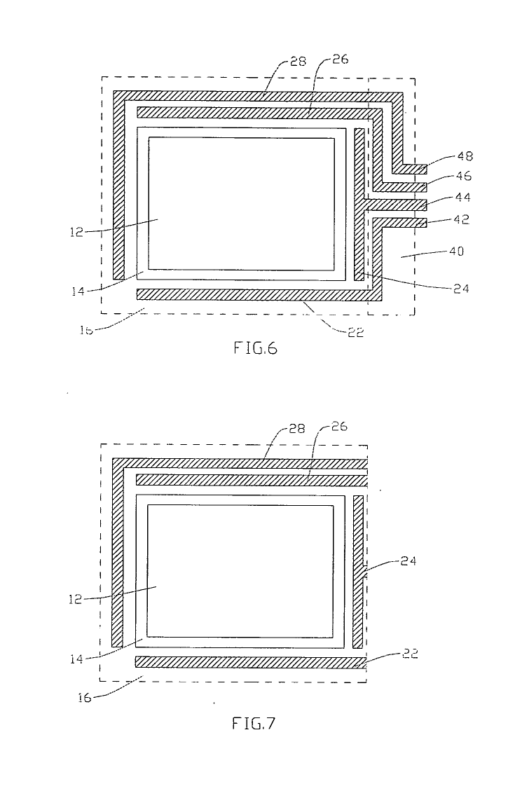

The second embodiment of this invention is illustrated in the FIG. 6. The FPC 40 is disposed at the output terminal area of the touch panel 10. An active area 12 is located in the middle area of the touch panel 10 to detect the touching position of a pen or finger. Most areas of the touch panel 10 must be transparent if the touch panel 10 is put on the liquid crystal display device, and the transparent area 14 is bigger than the active area 12. At the surroundings of the active area 12, four conductive lines 22, 24, 26, 28 are disposed around the active area 12 and connected electrically with the electrode plates of the touch panel respectively. The four conductive lines 22, 24, 26, 28, which material are silver, are located in the conductive area 16. A FPC 40 with four conductive lines 42, 44, 46, 48 is disposed at the output terminal area of the touch panel 10. The conductive lines 42, 44, 46, 48 are connected respectively to the conductive line 22, 24, 26, 28. The FPC 40 can be connected to the touch panel 10 by the bonding method.

The area of the FPC 40 is taken away from the entire area of the touch panel 10 after the FPC 40 is folded, as shown in the FIG. 7. Besides, the thickness of the FPC 40 is very thin, so it adds only little volume of the touch panel 10. The request of slim body and small volume for touch panel 10 can be made easily.

For convenience, we use the resistance-type touch panel with four conductive lines and the material of conductive lines is silver in the above embodiments. However, the scope of the present invention is not limited in the resistance-type touch panel with four conductive lines and the silver conductive lines. It can reduce more areas when this invention is used in the resistance-type touch panel with six/eight conductive lines.

In the present invention, not only a FPC is connected to one edge of the touch panel, but also two FPCs can be connected simultaneously to two edges of the touch panel. For example, we can incorporate simultaneously the two FPCs in the first and second embodiments into the two edges of one touch panel. Then, the areas of two/four sides of the touch panel can be equalized.

There are many advantages that a FPC is incorporated into the touch panel to diminish the entire area of touch panel according to the present invention. The FPC is connected to one edge of touch panel by the bonding method, and the FPC with parts of the conductive lines put originally on the edge of touch panel is folded and overlapped over touch panel. Besides, the areas of two/four sides of touch panel are equalized, and then the touch panel can be incorporated into more consumer electrical products. Finally, the weight of touch panel can be reduced while the edges of touch panel are replaced with the FPC.

Although the specific embodiment has been illustrated and described, it will be obvious to those skilled in the art that various modifications may be made.

1. A touch panel, comprising:
an upper electrode plate;
a lower electrode plate being isolated electrically with said upper electrode plate;
a plurality of conductive lines connected electrically to said upper electrode plate and said lower electrode plate respectively; and
a flexible printed circuit board (FPC) connected electrically to a terminal area of said touch panel, parts of said plurality of conductive lines located on said terminal area, wherein the folded parts of said FPC are overlapped over said touch panel.

2. The touch panel according to claim 1, further comprising a second FPC connected electrically to said touch panel.

3. The touch panel according to claim 1, wherein said plurality of conductive lines are the silver lines.

4. The touch panel according to claim 1, wherein said FPC is connected electrically to said touch panel by the bonding method.

5. The touch panel according to claim 1, further comprising a plurality of dot spacers located in between said upper electrode plate and said lower electrode plate.

6. The touch panel according to claim 1, further comprising an adhesion layer disposed between said upper electrode plate and said lower electrode plate to adhere said upper and lower electrode plate.

7. The touch panel according to claim 1, wherein said upper electrode plate includes a first base substrate and an upper conductive layer formed beneath said first base substrate, and said lower electrode plate includes a second base substrate and a lower conductive layer formed on said second base substrate.

8. A touch panel comprising:
a first electrode plate;
a second electrode plate being isolated electrically with said first electrode plate;
a plurality of first conductive lines connected electrically to said first electrode plate and said second electrode plate respectively; and
a flexible printed circuit board (FPC) connected electrically to a terminal area of said touch panel by the bonding method, a plurality of second conductive lines located on said FPC and connected electrically with said plurality of first conductive lines, wherein the folded parts of said FPC are overlapped over said touch panel.

9. The touch panel according to claim 8, wherein said plurality of first conductive lines and said plurality of second conductive lines are the silver lines.

10. The touch panel according to claim 8, further comprising an adhesion layer disposed between said first electrode plate and said second electrode plate to adhere said first and second electrode plate.

11. The touch panel according to claim 8, wherein said first electrode plate includes a first base substrate and a first conductive layer formed on said first base substrate, and said second electrode plate includes a second base substrate and a second conductive layer formed on said second base substrate.

12. The touch panel according to claim 8, further comprising a second FPC connected electrically to said touch panel.

13. The touch panel according to claim 8, further comprising a plurality of dot spacers located in between said first electrode plate and said second electrode plate.
